(19) United States
(12) Patent Application Publication
(10) Pub. No.: US 2010/0014065 A1
(43) Pub. Date: Jan. 21, 2010

(54) METHOD FOR IMPROVING IMAGING PROPERTIES OF AN OPTICAL SYSTEM, AND SUCH AN OPTICAL SYSTEM

(75) Inventors: Toralf Gruner, Aalen-Hofen (DE); Yim-Bun Patrick Kwan, Aalen (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 12/552,894

(22) Filed: Sep. 2, 2009

Related U.S. Application Data
(63) Continuation of application No. PCT/EP2008/002289, filed on Mar. 20, 2008.

(30) Foreign Application Priority Data
Mar. 20, 2007 (DE) 102007014740.8

(51) Int. Cl. G03B 27/54; G02B 7/00; G03B 27/70

(52) U.S. Cl. 355/67; 359/820

(57) ABSTRACT

The disclosure relates to a method for improving optical properties of an optical system. The optical system has a plurality of optical elements for imaging a pattern onto a substrate that is arranged in an image plane of the optical system. The method includes detecting at least one time-dependent, at least partially reversible aberration of the optical system that is caused by heating of at least one of the optical elements. The method also includes at least partially correcting the aberration by replacing at least one optical element from the plurality of optical elements with at least one optical compensation element. The disclosure also relates to such an optical system with improved imaging properties.

### CROSS-REFERENCE TO RELATED APPLICATIONS

This application is a continuation of, and claims priority under 35 USC §120, to international patent application PCT/EP2008/002289, filed Mar. 20, 2008 which claims benefit of German patent application 10 2007 014 740.8, filed Mar. 20, 2007. The entire contents of international application PCT/EP2008/002289 are hereby incorporated by reference.

### FIELD

The disclosure relates to a method for improving imaging properties of an optical system. The disclosure also relates to an optical system with improved imaging properties. Such an optical system can be, for example, a projection objective and/or an imaging system in an illumination system of a projection exposure machine that is used in microlithography to produce finely patterned components.

### BACKGROUND

A projection exposure machine can be used to image a structure or a pattern of a mask (reticle) onto a photosensitive substrate. The projection exposure machine includes as illumination source with an associated illumination system, a holder for the mask, a substrate table for the substrate that is to be exposed, and a projection objective between the mask and the substrate. The light beams generated by the illumination source pass through the illumination system, illuminate the mask and, after passing through the projection objective, strike the photosensitive substrate. Typically, the mask is arranged in an object plane of the projection objective, and the substrate is arranged in the image plane of the projection objective. The illumination system has an optical imaging system that serves to image a stop onto the mask (reticle), and thus defines the region to be exposed on the mask.

The imaging properties of the illumination system and, in particular, of the projection objective are usually important to the imaging quality of the projection exposure machine. In view of an increasing integration density of the components, the patterns to be imaged are becoming ever smaller such that increasingly higher demands are being placed on the imaging quality of the projection exposure machine.

The imaging properties of the illumination system and of the projection objective of the projection exposure machine can be impaired by the passage of light beams through the optical elements accommodated in the projection exposure machine. The resulting aberrations impair the imaging quality of the projection exposure machine.

Short-term, reversible aberrations can occur due to a heating of the optical elements by, for example, 1/10 K to 1 K, which can result in reversible variation of the shape and/or the material properties (refractive index etc.) of the optical elements. The operating time of the projection exposure machine, during which the aberrations caused exceed a value that is acceptable for the projection exposure machine, is in the range of a few minutes. If the heated optical elements cool to their normal temperature because, for example, of a lack of light beam cross section, the aberrations are minimized until they finally vanish. On the other hand, service life effects of the optical elements can impair the imaging properties of the optical system when the permanent action of radiation on the optical elements alter their material density, that is to say their optical properties, for example (compaction, rarefaction). It is possible that the irreversible material change to the optical elements is caused by a deposition of the light beam energy in the optical elements, which leads to a heating of the optical elements and to a change in the chemical structure of the optical elements, resulting in a change in refractive index or a reduction in the transmittance of the optical elements. These long term, irreversible aberrations occur in an operating period of the projection exposure machine lasting a few months to years. In particular, illumination poles that are, for example, produced by illumination masks or gratings arranged in the illumination system, lead to a localized, intense heating of the optical elements that is particularly noticeable in the region of the projection objective that is near a pupil, causing more aberrations in these regions.

It is generally known that aberrations that occur because of the beam induced damage to the optical elements and permanently impair their imaging properties can be at least partially corrected by replacing at least one optical element in the projection exposure machine, in particular in the projection objective.

### SUMMARY

In some embodiments, the disclosure provides a method for improving imaging properties of an optical system. The method can improve imaging properties of an optical system that are impaired by time-dependent reversible aberrations which are caused by heating at least one optical element accommodated in the optical system.

In certain embodiments, the disclosure provides an optical system having improved imaging properties.

In some embodiments, the disclosure provides a method for improving imaging properties of an optical system, having a plurality of optical elements, in order to image a pattern onto a substrate that is arranged in an image plane of the optical system. The method includes (a) detecting a time-dependent, at least partially reversible aberration of the optical system that is caused by heating of at least one of the optical elements, and (b) at least partially correcting the aberration by replacing at least one optical element from the plurality of the optical elements with at least one optical compensation element.

In certain embodiments, the disclosure provides an optical system with improved imaging properties, in which the optical system has a plurality of optical elements. A replacing apparatus is coupled to the optical system. The replacing apparatus has a plurality of optical compensation elements. It is possible to use the replacing apparatus to replace at least one optical element with at least one optical compensation element.

The disclosure provides methods and optical systems that improve the imaging properties of the optical system by virtue of the fact that an at least time-dependent, at least partially reversible aberration of the optical system is detected and at least partially corrected by replacing at least one optical element of the optical system with at least one optical compensation element. It is possible as a result for the aberration to be very efficiently corrected and in a time-saving fashion since, after the aberration has been detected, the optical element to be replaced can be selected, and replaced, on the basis of the knowledge of the aberration. There is no imperative need in this case to replace the optical element that causes the aberration. Rather, it is possible to replace an optical element with an optical compensation element such as can be used to correct the wavefront aberration profile of the optical system most effectively and in a very simple way. The optical compensation element can have a form deviating from the optical element to be replaced, and deviating optical properties (refractive index etc.).

A further advantage is based on the fact that there is no need for optical compensation elements corresponding to all the optical elements of the optical system to be kept ready. Rather, a few compensation elements that can be introduced in common into a beam path of the optical system enable complicated wavefront aberration profiles of the optical system to be effectively corrected.

The optical system optionally has a detection device for detecting at least one time-dependent, at least partially reversible aberration of the optical system that is caused by heating of at least one of the optical elements.

While the optical system itself can have an appropriate detecting device, in some embodiments, the detecting device is provided separately from the optical system, that is to say be designed as an external detecting device.

In some embodiments, in which the replacing apparatus is coupled to the optical system, the replacing apparatus has a magazine in which the plurality of optical compensation elements are accommodated. The magazine is coupled to the optical system, and the same atmospheric conditions prevail in the magazine as in the optical system, at least in the region of the same to which the magazine is coupled.

In such embodiments, the magazine of the replacing apparatus is therefore advantageously incorporated into the operating environment of the optical system, as a result of which the same operating conditions prevail in the magazine as in the optical system. The at least one compensation element can therefore be inserted into the optical system without, for example, the need for the optical system to be once again cleaned by purging or evacuated after the replacement of an optical element.

The atmospheric conditions mentioned above can include the gas composition in the magazine and in the optical system. It is possible for the gas composition to be air or helium, for example, or a vacuum if such prevails in the optical system, as is the case, for example, with catoptric optical systems in EUV lithography.

In addition or as an alternative, the atmospheric conditions can also include the pressure and/or the temperature in the magazine and in the optical system.

In some embodiments, (a) and (b) are carried out repeatedly.

This measure has the advantage that the correction of the aberration is dynamically adapted to the temporal development of the aberration. In particular, it is possible to detect the aberration at various times and to reduce it by replacing an optical element with an optical compensation element. With each renewed correction, it is then possible to introduce a composition element such that it corrects a relatively large amplitude of aberration until the first aberration is completely compensated.

In certain embodiments, the aberration is detected during an operation of the optical system by directly measuring a wavefront aberration profile of the optical system.

This measure makes it possible to detect the at least first aberration precisely during the aberration of the optical system without the need for a relatively long downtime of the system.

In some embodiments, the aberration is detected by estimating a light distribution in the optical system as a function of an illumination mode of the optical system and of the pattern to be imaged by the plurality of the optical elements.

This measure makes it possible to detect the aberration in a simple way. Estimating the light distribution in the optical system is based on a knowledge of layer and volume absorption coefficients of the plurality of the optical elements. Starting from the illumination mode of the pattern by the illumination source and the illumination system, the intensity absorbed in the optical elements and the temperature distribution of the optical elements are determined. By way of example, it is possible to calculate the thermal expansions and the temperature-dependent changes in refractive index of the optical elements from which the wavefront aberration profile of the optical system can be determined in advance.

In some embodiments, the aberration is detected by measuring the light distribution in the optical system in a pupil plane of the optical system, or in a plane near a pupil.

This can make it possible to detect aberrations with a constant field profile. Measuring the light distribution in the optical system in a pupil plane or a plane near a pupil can be carried out at a position at which the at least first optical compensation element can later be introduced.

In some embodiments, the aberration is detected by measuring the light distribution in the optical system in a field plane or a plane near the field and/or an intermediate plane of the optical system.

This can make it possible to detect aberrations with a non-constant field profile. Measurement of the light distribution can be carried out at positions at which the at least first optical compensation element can later be introduced into the beam path of the optical system.

In certain embodiments, the aberration is detected by comparing the measured light distribution in the optical system with reference light distributions.

This can make it easy to detect the aberration. Since the aberrations of the reference light distributions are known, it is possible to infer the at least first aberration from the reference light distributions directly, without further complicated measurements.

In certain embodiments, before (b), a temporal development of the imaging properties of the optical system is determined as a function of already occurring aberrations, such as the detected aberration.

This measure has the advantage that certain aberrations can be optimally predicted and thus effectively corrected. Furthermore, if other aberrations occurring in the optical system at earlier instants are known, it is possible for these also to be incorporated in order that the at least first aberration can be corrected even more precisely.

In some embodiments, before (b), a best possible achievable correction of the aberration is determined by taking account of all possibilities of correction.

This measure has the advantage that the optimally possible correction of the aberration can be used to determine an optical element that is then replaced by a suitable optical compensation element and most effectively corrects the aberration in combination with further possibilites of correction, such as, for example, displacement with reference to the optical axis and/or tilting with reference to the optical axis and/or rotation about the optical axis and/or also by deformation, caused by mechanical and/or thermal force effect, of one or more optical elements and/or the optical compensation element to be introduced. Furthermore, a possibility of correction that can be carried out with the least outlay on manipulation can be selected from the possibilities of correction possible for the at least first aberration.

In some embodiments, a plurality of optical compensation elements are provided that include a first optical compensation element, and the first optical compensation element is introduced into the beam path of the optical system on its own in order to correct the at least first aberration.

This measure has the advantage that the aberration can be corrected in a particularly time saving fashion, since only a single optical element is replaced with a single optical compensation element. Furthermore, it is technically easier to introduce only a single optical compensation element than to introduce a number of optical compensation elements.

In some embodiments, first and second optical compensation elements are introduced simultaneously into the beam path of the optical system in order to correct the at least first aberration in combination with one another.

This measure has the advantage that a complicated wavefront aberration profile can be particularly quickly corrected by the simultaneous introduction of a plurality of optical compensation elements. For example, an optical element can be replaced with a plurality of optical compensation elements or, as an alternative, a plurality of optical elements can be replaced with a plurality of optical compensation elements, the number of the replaced optical elements and the optical compensation elements not necessarily being equal.

In certain embodiments, the first and second optical compensation elements constitute elementary compensation elements whose overall corrective effect is a desired corrective effect for the at least first aberration of the optical system.

This measure has the advantage that it is easily possible to correct elementary basic orders of aberrations by introducing single elementary compensation elements, and higher orders of aberrations, which result from linear combinations of the basic orders of the aberrations, by introducing a plurality of different elementary compensation elements in combination. Here, “elementary compensation element” is to be understood as an optical compensation element that can correct elementary aberrations given by the basic orders of the Zernike functions.

The first optical compensation element and/or the second optical compensation element can be introduced in a pupil plane or near the field, in a field plane or near the plane, and/or at intermediate positions of the optical system.

In some embodiments, the optical elements and the optical compensation elements form plane parallel plates, lenses and/or mirrors.

This measure has the advantage that various basic designs of optical elements are provided, in particular for the optical compensation elements, in order to be able to effectively correct the at least first aberration of the optical system.

In certain embodiments, the optical compensation elements designed as plane parallel plates have second-, third-, fourth- and/or nth-order fit errors with various amplitudes.

This measure offers various refinements of the compensation elements in the form of plane parallel plates whose properties are respectively advantageously best adapted to the desired properties for correcting the aberration. Furthermore, it is possible to provide special plane parallel plates with the aid of which aberrations occurring particularly frequently can be effectively corrected at once.

In certain embodiments, the optical compensation elements designed as plane parallel plates have rotationally or non-rotationally symmetrical fit errors.

This measure has the advantage that various types of compensation elements are provided with regard to rotational symmetry in order to be able to effectively correct aberrations of the optical system with and without rotational symmetry. In particular, plane parallel plates with rotationally symmetrical fit errors have the advantage that after being introduced into the optical system it can simply be rotated about the optical axis for adjustment purposes without varying their corrective action. In contrast, when rotating by a defined angle about the optical axis, plane parallel plates with non-rotationally symmetrical fit errors enable a predictable corrective action deviating from the corrective action in the non-rotated state.

In this case, it is possible, in particular, for the optical compensation elements, designed as plane parallel plates, with non-rotationally symmetrical fit errors optionally to have a substantially cylindrical or conical periphery.

In some embodiments, the fit errors are determined by Zernike functions and/or splines.

Since aberrations are usually classified by Zernike functions, this measure advantageously provides optical compensation elements with the aid of which specific Zernike functions of aberrations can be corrected in a targeted fashion.

In certain embodiments, the fit errors correspond to a field constant Z6 profile whose amplitude is at least 10 nm, such as 5 nm.

In some embodiments, the fit errors correspond to a field constant Z10, Z11, Z17 or Z18 profile whose amplitude is at least 5 nm, such as 2 nm.

In certain embodiments, the at least first optical element is replaced in under ten minutes (e.g., under three minutes, under one minute).

This measure has the advantage that the at least first optical element can be quickly replaced such that no waiting times result during operation of the optical system. Consequently, a loss of use during operation of the optical system is avoided.

In some embodiments, the at least first optical element is replaced in an at least partially automated fashion.

This measure has the advantage that the operation of the optical system, in particular the maintenance time, can be carried out without, or with a slight, outlay on manpower. Consequently, the optical system can be operated in a cost-effective fashion. Furthermore, errors in the replacement of the at least first optical element with at least one first optical compensation element owing to operating errors during the replacement operation are reduced.

In certain embodiments, in addition, the optical compensation element and/or the optical elements introduced into the optical system are/is rotated, tilted with reference to an optical axis, and/or displaced in the optical system.

This measure advantageously provides supplementary possibilities of correcting the optical elements and the optical compensation element by adjustment that, in combination with the replacement of the at least first optical element, can optimally correct the at least first aberration. Here, a “displacement” of the optical elements and the optical compensation elements introduced into the optical system is to be understood as a displacement along and/or transverse to the optical axis of the optical system.

In certain embodiments, in addition, the optical compensation element and/or the optical elements introduced into the optical system are/is deformed by mechanical and/or thermal force action.

This measure has the advantage that yet further correction possibilities are provided for correcting the at least first aberration, and the possibilities can advantageously be combined with the correction by replacing individual elements.

Again, in addition the pattern and/or the substrate can be displaced.

In some embodiments, in addition, a wavelength and/or an irradiation dose are/is varied by light beams incident on the optical system.

This measure has the advantage that yet further correction possibilities are provided for correcting the at least first aberration, which possibilities involve no action on the optical system itself and can therefore be carried out in a simple way. Changing the radiation dose of the light beams is carried out, in particular, whenever this is possible during operation of the projection exposure machine by taking account of the desired manufacturing throughput of the substrates to be exposed.

It is possible to apply the previously described method to improve the imaging properties of an optical system.

The optical system can be a projection objective of a projection exposure machine for microlithography, or an optically imaging system in an illumination system of a projection exposure machine for microlithography that serves to image an stop in a reticle plane.

In both cases, the optically imaging system can be a dioptric, catadioptric or catoptric imaging system.

While in the case of a catadioptric or dioptric optical system plane plates are optionally introduced into the optical system from the replacing apparatus, in the case of a catoptric system, particularly when it is operated with wavelengths for which there is no suitable transmissive optical elements, it can be advantageous to replace at least one mirror of the catoptric system.

Operating wavelengths of the optical system include 248 nm, 193 nm or 13 nm. The optical system in the case of the last named operating wavelength is catoptric.

Further advantages and features can emerge from the following description and the attached drawing.

It goes without saying that the abovementioned features and those to be explained below can be used not only in the specified combinations, but also in other combinations or on their own without departing from the scope of the disclosure.

### BRIEF DESCRIPTION OF THE DRAWINGS

The disclosure is provided in more detail and explained below with the aid of some selected exemplary embodiments in conjunction with the attached drawings, in which:

FIG. 1 shows a schematic of a projection exposure machine with an illumination system and a projection objective;

FIG. 2 shows a cross-sectional drawing of the projection objective in FIG. 1;

FIG. 3 shows a flowchart of an exemplary embodiment of a method;

FIG. 4A shows two examples of aberrations, caused by heating of at least one of the optical elements, for two operating modes of the projection exposure machine;

FIG. 4B shows two examples of the aberrations in FIG. 4A that have been corrected at least partially by correction possibilities known from the prior art;

FIG. 5 shows an optical system in the form of a dioptric projection objective for use in the projection exposure machine in FIG. 1;

FIG. 6 shows a catadioptric projection objective for use in the projection exposure machine in FIG. 1;

FIG. 7 shows a catadioptric projection objective for use in the projection exposure machine in FIG. 1;

FIG. 8 shows a catoptric projection objective for use in the projection exposure machine in FIG. 1; and

FIG. 9 shows an optical system for use in the illumination system of the projection exposure machine in FIG. 1, the optical system serving to image a stop in a reticle plane of the projection exposure machine in FIG. 1.

### DETAILED DESCRIPTION

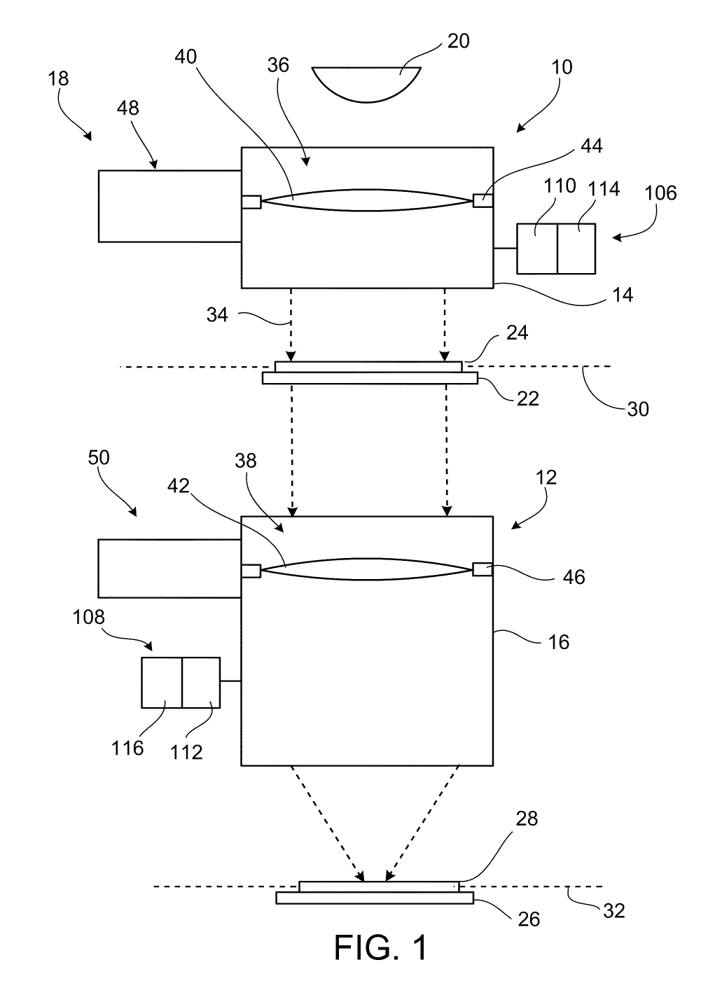

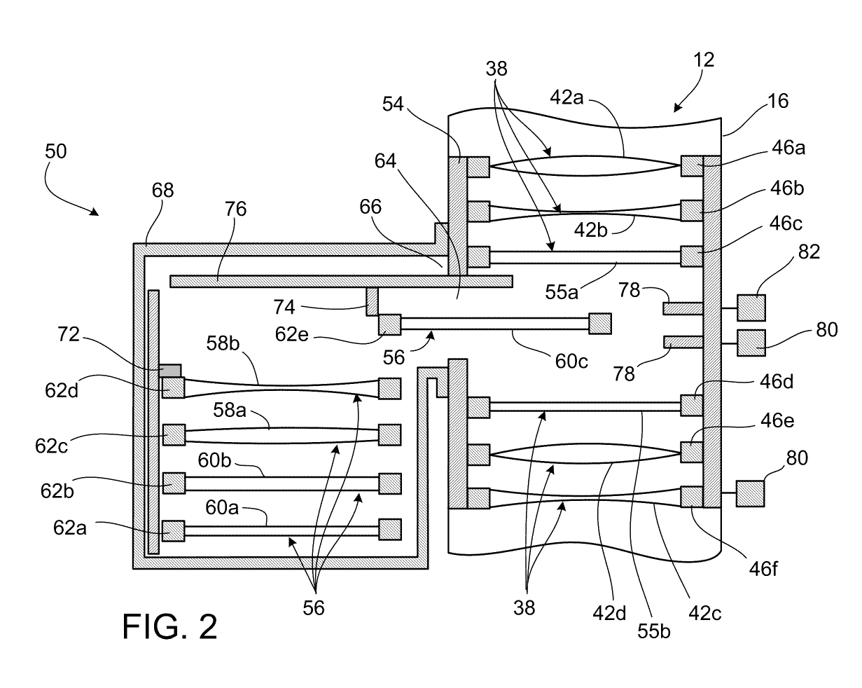

FIG. 1 illustrates two optical systems provided with the general reference symbols 10, 12. Further details of the optical system 12 are illustrated in FIG. 2. The optical systems 10, 12 constitute an illumination system 14 and a projection objective 16 of a projection exposure machine 18 that is, for example, used in semiconductor microlithography for producing finely patterned components.

In addition to the illumination system 14 and the projection objective 16, the projection exposure machine 18 has a light source 20, a holder 22 for a pattern 24 in the form of a mask (reticle) between the illumination system 14 and the projection objective 16, as well as a substrate table 26 for a photosensitive substrate 28 (wafer). The pattern 24 or the substrate 28 are arranged in an object plane 30 or in an image plane 32 of the projection objective 16.

The illumination system 14 serves to produce specific properties of light beams 34 such as, for example, polarization, coherence, diameter and the like.

During an exposure operation of the substrate 28, the light beams 34, which are produced by the light source 20, pass through the illumination system 14 and through the pattern 24. The light beams 34 furthermore pass through the projection objective 16 and reach the photosensitive substrate 28. After this exposure operation, the substrate 28 can be displaced on the substrate table 26 such that the patterns 24 contained in the mask can be repeatedly imaged in a demagnified state on a multiplicity of fields on the substrate 28.

The illumination system 14 and the projection objective 16 have a plurality of optical elements, schematically here respectively an optical element 36, 38. The optical elements 36, 38 can be designed as plane parallel plates, lenses and/or mirrors. In FIG. 1, the optical element 36, 38 is respectively designed as a lens 40, 42 that is arranged in a respective mount 44, 46 in the illumination system 14 and the projection objective 16.

The optical element 36 of the illumination system 14 is illustrated here for an optical system inside the illumination system 14 that serves to image a stop (not illustrated in more detail) in the reticle plane of the projection exposure machine 18, which is formed by the object plane 30.

During the operation of the projection exposure machine 18, the imaging properties of the illumination system 14 and the projection objective 16 can worsen such that the imaging quality of the projection exposure machine 18 and, in particular, of the projection objective 16 is reduced. For example, heating of at least one of the optical elements 36, 38 can cause at least one first, time-dependent, at least partially reversible aberration. The heating of the optical element 38 of the projection objective 16 is, in particular, intensified by illumination poles that are produced, for example, by gratings or illumination masks (not shown) arranged in the illumination system 14.

For the purpose of at least partially correcting the at least first aberration, at least one first optical element 36, 38 from the plurality of the optical elements is replaced with at least one first optical compensation element (see FIG. 2, for example), as is explained in more detail further below. Provided for this purpose in the projection exposure machine 18 are replacing apparatuses 48, 50 that are respectively coupled to an optical system 10, 12, optionally outside a beam path of the optical system 10, 12.

Furthermore, a plurality of replacing apparatuses 48, 50 can respectively be provided for an optical system 10, 12, by way of example the at least first optical element 36, 38 being removed from the optical system 10, 12 by a replacing apparatus 48, 50, and the at least first optical compensation element being introduced into the optical system 10, 12 by a further replacing apparatus 48, 50.

It is likewise possible for the replacing apparatus 48, 50, which respectively provides specific compensation elements, to be replaced with other replacing apparatuses with other compensation elements. Again, it is possible, for example, to replace only one magazine of the replacing apparatus 48, 50, which contains a specific number of compensation elements, with another magazine with other compensation elements.

Each replacing apparatus 48, 50 has a plurality of optical compensation elements that can be designed as plane parallel plates, lenses and/or mirrors.

The at least first optical element 36, 38 of the optical system 10, 12 is replaced with the at least first optical compensation element by the replacing apparatus 48, 50. The at least first optical element 36, 38 is herein removed from the beam path of the optical system 10, 12, and the at least first compensation element is introduced into the beam path of the optical system 10, 12. The at least first optical compensation element can be introduced into the beam path of the optical system 10, 12 on its own. It is likewise possible for the at least first optical compensation element and at least one second optical compensation element, that is to say a plurality of optical compensation elements whose number can be determined before they are introduced into the optical system 10, 12, to be pushed simultaneously into the beam path of the optical system 10, 12. For the purpose of at least partially correcting the at least first aberration of the optical system 10, 12, there is no imperative need to replace that optical element 36, 38 which causes the at least first aberration. Rather, such an optical element 36, 38 of the optical system 10, 12 can be replaced with at least the first optical compensation element such that this at least first aberration is at least partially corrected by the difference between the removed optical element 36, 38 and the introduced optical compensation element. The at least first optical compensation element, which is introduced into the beam path of the optical system 10, 12, can consequently have a form deviating from the replaced optical element 36, 38, and deviating optical properties (refractive index etc.).

If a plurality of optical compensation elements are introduced into the beam path of the optical system, these optical compensation elements are optionally designed as elementary compensation elements whose total corrective action is a desired corrective action for the at least first aberration of the optical system 10, 12. An “elementary compensation element” is to be understood as an optical compensation element that can correct elementary aberrations which are produced, for example, by the basic orders of Zernike functions.

FIG. 2 shows an enlarged portion of the optical system 12, that is to say the projection objective 16. By way of example, six optical elements 38 are arranged in a housing 54 of the projection objective 16 in the form of four lenses 42a-d and two plane parallel plates 55a, b into a mount 46a-f, respectively. The replacing apparatus 50 is coupled to the housing 54, the replacing apparatus 50 having a magazine or housing 68 in which, for example, five optical compensation elements 56 in the form of two lenses 58a, b and three plane parallel plates 60a-c are accommodated in one mount 62a-e each. The projection objective 16 and the replacing apparatus 50 are connected to one another via in each case a lateral opening 64, 66 in the housing 54 of the projection objective 16 and in the housing 68 of the replacing apparatus 50. The at least first optical element 38, or else a plurality of optical elements 38, can be removed from the housing 54 of the projection objective 16 through these openings 64, 66, and the at least first optical compensation element 56, or else a plurality of optical compensation elements 56, can be introduced into the housing 54 of the projection objective 16.

The atmospheric conditions prevailing in the magazine 68 of the replacing apparatus 50 are the same as those in the optical system 12, which is formed here by the projection objective 16, at least in the region of the projection objective 16 to which the magazine 68 of the replacing apparatus 50 is coupled. The atmospheric conditions can include the gas composition in the interior of the magazine 68 and the optical system 12 in the region thereof along the optical axis of the coupling of the magazine 68 to the optical system 12.

If the gas composition in the optical system 12 is, for example, air in this region, the magazine 68 is also filled with air. If the gas composition in the optical system 12 in the region of the coupling of the magazine 68 to the optical system 12 consists, for example, of helium, the magazine 68 is also filled with helium. If there is a vacuum in the optical system 12 in the region of the coupling of the magazine 68 to the optical system 12, a vacuum also prevails in the magazine 68.

The atmospheric conditions can include the same pressure in the magazine 68 and in the optical system 12, as well as the same temperature in these two systems.

The above description with reference to the same atmospheric conditions in the replacing apparatus 50 and in the optical system 12 are optionally equally valid in a corresponding way for the replacing apparatus 48 in the illumination system 14 of the projection exposure machine 18.

A changing device 70 that is arranged in the replacing apparatus 50 can be used to bring the selected optical compensation element 56 which is to be introduced into the housing 54 of the projection objective 16 into the position which is expedient for this. To this end, the changing device 70 has a fastening element 72 on which the selected optical compensation element 56 can be fastened such that the optical compensation element 56 can be raised, displaced in a plane of the optical compensation element, tilted with reference to a vertical axis through a center point of the optical compensation element, and be rotated about this axis. If the replacing apparatus 50 is arranged in such a way on the housing 54 that the compensation elements 56 are held ready above the opening 64 in the housing 54 of the projection objective 16 in the replacing apparatus 50, the compensation element 56 to be introduced is lowered to the level of the lateral openings 64, 66 in the housing 54, 68 of the projection objective 16 or the replacing apparatus 50.

Furthermore, a holding apparatus 74 that is arranged on a guide 76 is provided in the replacing apparatus 50 for the purpose of replacing the at least first optical element 38 with the at least first optical compensation element 56. The guide 76 can, for example, be operated by a motor (not illustrated) such that the replacement is performed in optionally under ten minutes (e.g., under three minutes, under one minute), and at least in a partially automated fashion. As shown in FIG. 2, an optical element 38 has already been removed from the projection objective 16, and the at least first optical compensation element 56 of the five optical compensation elements 56 is introduced into the housing 54 of the projection objective 16 by the holding apparatus 74 and the guide 76.

After the introduction of the at least first optical compensation element 56, the mount 62 of the optical compensation element 56 is fastened by a fixing device 78 that is arranged inside on the housing 54 of the projection objective 16. For example, the fixing device 78 can be designed as a spring-loadable clamping device or as a simple plug-in connection in which the mount 62 of the optical compensation element 56 is clamped or held by frictional resistance. In the schematically illustrated exemplary embodiment, the fixing device 78 is arranged on both sides of the mount 62 of the optical compensation element 56. It can likewise also be provided that the fixing device 78 acts on the mount 62 only on one side. Likewise, instead of being fastened at one position, the optical compensation element 56 can be fastened at two different positions, in particular at two mutually opposite positions, on the housing 54 of the projection objective 16. This configuration of the fixing device 78 increases the stability of the introduced optical compensation element 56, in particular when it has an increased weight in conjunction with a large diameter.

If, instead of the plane parallel plates 60a-c, lenses 58a, b, or else mirrors or prisms, are introduced into the beam path of the projection objective 16, the fixing device 78 in the projection objective 16 desirably has an adequate centering accuracy for these optical compensation elements 56.

Depending on the corrective action desired, the optical compensation elements 56 can be introduced into the beam path of the projection objective 16 near a pupil, near the field and/or at intermediate positions.

In order to at least partially correct the at least first aberration of the projection objective 16, optical compensation elements 56 that respectively have different forms and optical properties are provided in the replacing apparatus 50.

The plane parallel plates 60a-c optionally have different thicknesses D and different fit errors with different amplitudes, it being possible for the fit errors to be given by Zernike functions and/or splines. The fit deformation of the plane parallel plates 60a-c can be of second, third, fourth or else higher order (nth order), for the purpose of correcting complicated wavefront aberration profiles. Furthermore, the amplitudes of the fit deformations can have a graduation suitable for correcting the at least first aberration, that is to say the amplitudes of the fit deformations are greater than a minimum amplitude below which no correction of the at least first aberration is possible, and they can, for example, be graded in powers to the base of two. Furthermore, the fit errors of the optical compensation elements 56 are optionally designed in a rotationally symmetrical or non-rotationally symmetrical fashion. The plane parallel plates 60a-c with non-rotationally symmetrical fit errors can have a substantially cylindrical or conical periphery.

Furthermore, such plane parallel plates 60a-c are optionally provided with non-rotationally symmetrical fit errors that are able, in the event of a rotation by a fraction of a specific angle α about the optical axis, in particular in the event of a rotation by half the angle α about the optical axis, to transform the fit errors of the plane parallel plates 60a-c into other Zernike functions. This angle α is defined in such a way that it constitutes the smallest angle for which the fit deformation of the plane parallel plates 60a-c is transformed into itself in the event of rotation by this angle about the optical axis. For example, the angle α is 180° C., 120° or 90° for a Z6, Z10/Z11 or Z17/Z18 deformation. By way of example, if the plane parallel plate 60a-c has a Z10 or Z17 profile as fit deformation, the rotation by 30° or 22.5° about the optical axis generates a Z11 or Z18 deformation, respectively. Furthermore, the rotation by 60° or 45° produces a negative fit deformation of the plane parallel plate 60a-c, and rotations by intermediate angles respectively produce a linear combination of these fit deformations.

The fit deformations of the plane parallel plate 60a-c can correspond to a field constant Z6 wavefront profile with an amplitude of at least 10 nm, such as 5 nm, such that an aberration with such a wavefront aberration profile in the exit pupil of the optical system 12 can be corrected by replacing the at least first optical element 38 of the projection objective 16. Furthermore, the fit deformation of the plane parallel plate 60a-c can correspond to a field constant Z10, Z11, Z17 and Z18 wavefront profile with an amplitude of at least 5 nm, such as 2 nm, in order to be able to correct such aberrations in the exit pupil of the optical system 12 by replacing the at least first optical element 38.

Furthermore, a plurality of plane parallel plates 60a-c can be provided as optical compensation elements 56 that exhibit the same fit deformations, for example of the same Zernike order, with different amplitudes. These plane parallel plates 60a-c can be used to correct a specific aberration of the optical system 12 that corresponds to the fit deformations of the plane parallel plates 60a-c, it being possible to correct different intensities of the at least first aberration depending on the amplitude of the fit deformations. For example, it is possible to provide ten compensation elements 56 that are respectively capable of correcting increasing 10%, 20%, 30% etc. of the maximum achievable strength of the at least first aberration that is reached by the at least first aberration after expiry of a specific time. Depending on the time that has passed, it is then possible to introduce into the optical system 12 such a compensation element 56 that at least partially corrects the instantaneous aberration.

Furthermore, it is possible to provide in the replacing apparatus 50 plane parallel plates 60a-c whose thicknesses constitute integral multiples of the thicknesses D of the plane parallel plates 60a-c. These plane parallel plates 60a-c can be introduced in positions in the beam path of the projection objective 16 at which no augmented lens heating occurs.

Furthermore, the replacing apparatus 50 can have optical compensation elements 56 that are specially adapted to the at least first aberration, which frequently occurs -in a specific projection objective 16, in order to at least partially correct this. Such optical compensation elements 56 are optimized for the frequently occurring aberration and can be distinguished from optical compensation elements 56 for other projection objective 16.

The replacement of the at least first optical element 38 of the projection objective 16 constitutes a correction possibility of the at least first aberration that can be used on its own or in various combinations with the following correction possibilities. These further correction possibilities can be carried out simultaneously with the replacement of the at least first optical element 38.

The further correction possibilities include displacing the optical elements 38 along and/or transverse to an optical axis, tilting them with respect to the optical axis, and rotating them about the optical axis. Furthermore, the introduced optical compensation elements 56 can be displaced along and/or transverse to the optical axis of the projection objective 16, tilted with reference to the optical axis of the projection objective 16, and rotated about the optical axis. Furthermore, the projection objective 16 has mechanical manipulators 80 and/or thermal manipulators 82 that are arranged on the optical elements 38 or the introduced optical compensation elements 56, respectively, in order to deform these by mechanical and/or thermal force action. It is possible hereby to vary optical properties (refractive index, density etc.) and the shape of the optical elements 38 or optical compensation elements 56. Furthermore, it is possible to displace the pattern 24 and/or the substrate 28, that is to say the holder 22 and/or the substrate table 26 of the projection exposure machine 18, along and/or transverse to the optical axis. Furthermore, a wavelength and/or an irradiation dose of the light beams 34, that is to say the light source 20, can be adapted. Here the irradiation dose can be varied for example by at most 10% or at most 40%. Replacing the at least first optical element 38 in combination with a change in the irradiation dose of the light beams 34 enables the at least first aberration to be at least partially corrected.

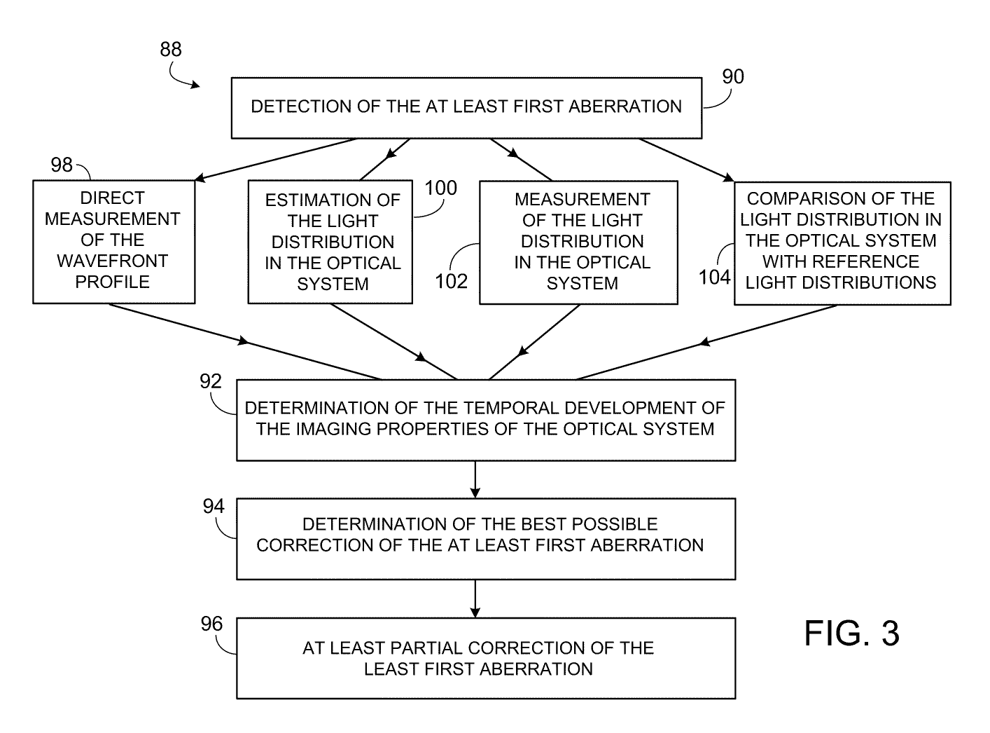

The at least partial correction of the at least first aberration is carried out during an inventive method 88 for improving imaging properties of the optical system 10, 12 (see FIG. 3). The inventive method 88 has inventive steps of detecting the at least first aberration 90, detecting the temporal development 92 of the imaging properties of the optical system 10, 12, determining the best possible correction 94 of the at least first aberration, and at least partially correcting the at least first aberration 96 by replacing at least one optical element 38 of the optical system 10, 12 with at least one first optical compensation element 56. The individual method steps 90-96 of the inventive method 88 can respectively be carried out on their own or in various combinations with one another. In particular, the method steps 90, 96 can be repeated iteratively at various consecutive instants in order to enable stepwise correction of the aberration. The correction to be carried out can take account of the temporal development of the aberration during the repeated measurement and correction of the aberration. The method steps 92, 94 can likewise be carried out, or else omitted, during the repeated execution of the method steps 90, 96.

The first method step 90, the detection of the at least first aberration, can be carried out by various substeps, it also being possible to use the latter in a fashion combined with one another. A first substep 98 is based on a direct measurement of the at least first aberration by measuring a wavefront profile of the optical system 10, 12. A wavefront detector such as, for example, ILIAS or Lightel, can be used to this end.

Furthermore, in a further substep 100 the light distribution in the optical system 10, 12 can be estimated as a function of the illumination mode of the optical system 10, 12 by the light beams 34 that are produced by the light source 20, and a configuration of the patterns 24 accommodated in the mask. Starting from a knowledge of layer and volume absorption coefficients of the optical elements 36, 38 of the optical system 10, 12, it is possible to determine the light intensity absorbed in the optical elements 36, 38, that is to say their temperature distribution. The resulting thermal expansions and the resulting temperature-dependent change in refractive index of the optical elements 36, 38, together with their effects on the total wavefront of the optical system 10, 12, can thereby be calculated.

Furthermore, the at least first aberration can be detected by a further substep 102, specifically measuring the light distribution in the optical system in one or more planes of the optical system 10, 12 before a substrate exposure to be carried out later. The measurement of the light distribution is optionally carried out by a detector, for example a CCD camera. In this case, the detector is positioned in planes in the optical system 10, 12 that are near a pupil, near a field and/or are intermediate planes. It is possible to select in the optical system 10, 12 planes into which the at least first optical compensation element 56 is later pushed. The light intensity stored in the individual optical elements 36, 38 of the optical system 10, 12 is determined on the basis of the measured light distribution. In accordance with the substep 100, the aberrations of the optical system 10, 12 can be inferred from this measured light distribution.

A further substep 104 for detecting the at least first aberration is performed via a comparison of the light distribution, as a function of field angle and diffraction angle, in the optical system 10, 12 with the aid of reference light distributions, dependent on field angle and diffraction angle, that have been determined previously in reference measurements. Since the wavefront aberration profiles of these reference light distributions are known, the at least first aberration can be determined in a simple way on the basis of the currently measured light distribution.

In order to carry out the substeps 98-104 of the method step 90, the optical system 10, 12 has a detecting device 106, 108 for detecting the at least first aberration of the optical system 10, 12 (see FIG. 1). A device 110, 112 for measuring a wavefront and/or a light distribution of the optical system 10, 12, for example the detector or the CCD camera, is provided in the detecting device 106, 108. Furthermore, the detecting device 106, 108 has an arithmetic logic unit 114, 116 for processing signals that can be fed to the arithmetic logic unit 114, 116 by the device 110, 112, and for driving the replacing apparatus 48, 50.

The method step 92, specifically the determination of the temporal development of the imaging properties of the optical system 10, 12, is carried out after the method step 90. The method step 92 is based on the knowledge of aberrations already occurring, in particular the at least first aberration. The temporal development of the at least first aberration can be calculated up to a few hours in advance.

Method step 94, specifically the determination of the best possible correction of the at least first aberration of the optical system 10, 12, takes account of a time duration for which the at least first aberration of the optical system 10, 12 is to be at least partially corrected. The optimally achievable correction can be carried out in this case via an optimization of a quadratic standard of different aberrations at various instants, the optimization of an integral value at various instants such as, for example, the RMS value of the wavefront, or via the optimization of corresponding maximum standards. In addition to replacement of the at least first optical element 36, 38 of the optical system 10, 12, it is possible in the method step 94 to incorporate all the previously illustrated correction possibilities.

As previously set forth, the method step 96, specifically the at least partial correction of the at least first aberration, is carried out by replacing the at least first optical element 36, 38 of the optical system 10, 12 with the at least first optical compensation element 56. All the previously mentioned supplementary correction possibilities can be incorporated in this case.

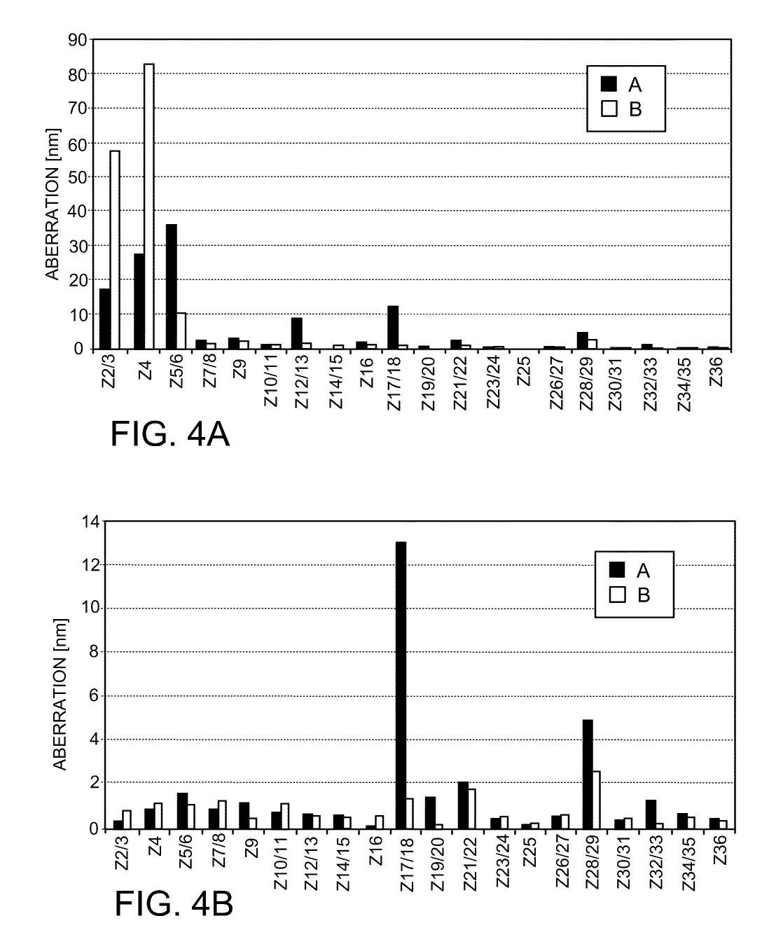

FIG. 4A shows by way of example the amplitudes of the aberrations of the projection objective 16, broken down by Zernike coefficients for two different exposure operations A, B of a mask that differ in the mode of illumination of the projection objective 16. A laser is used as light source 20 for both examples A, B. By contrast with an annular illumination in example B, example A has illumination poles and an average mask transmission that is half as great in percentage terms as that in example B. The patterns 24 of the mask, a laser power, a pulse repetition rate of the laser and a demagnification of the mask on the wafer are of equivalent design for the two examples A, B.

The mode of illumination in the example A produces chiefly Z5/Z6 and Z12/Z13 profiles (astigmatism) as well as Z17/Z18 and Z28/Z29 profiles (fourth order aberration). By contrast herewith, seen in absolute terms the mode of illumination in the example B produces larger aberrations (compare in this case the amplitude of the aberrations), but these are longwave in nature and can easily be corrected. These aberrations include, inter alia, Z2/Z3 profiles (distortion) and Z4 profiles (field curvature).

FIG. 4B shows the aberrations of the illumination examples A, B in FIG. 4A that are produced by the previously illustrated correction possibilities—apart from the replacement of the at least first optical element 38 of the projection objective 16. By contrast with the annular illumination (mode of illumination B), it is chiefly shortwave aberrations such as, for example, Z17/Z18 and Z28/Z29 profiles that result in example A. The profiles can be at least partially corrected by replacing the at least first optical element 38 in the projection objective 16.

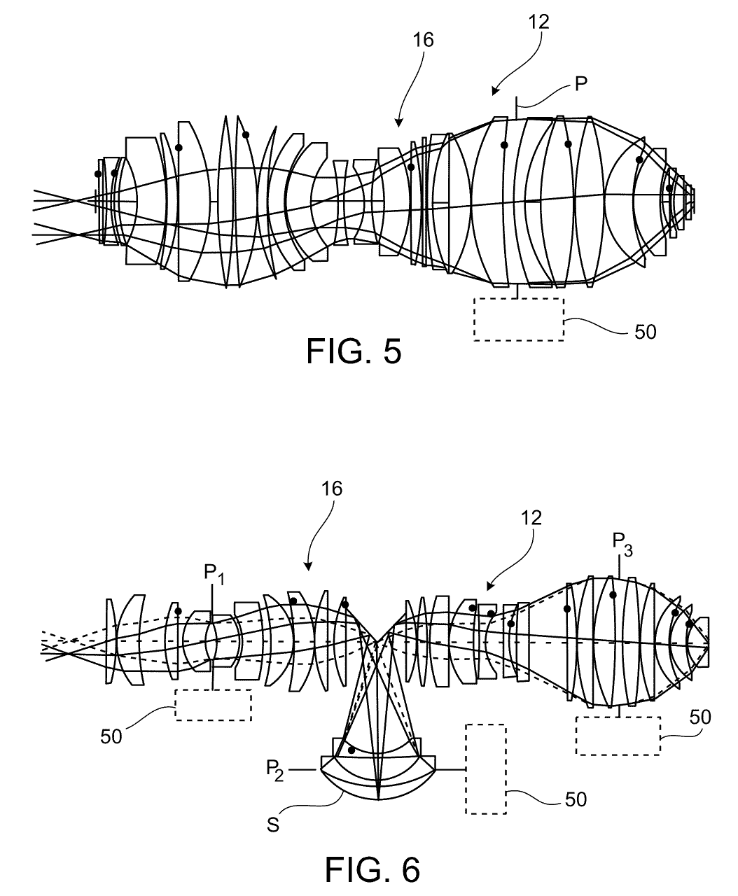

FIG. 5 illustrates a practical exemplary embodiment of the optical system 12 in FIG. 2, it being possible for the optical system 12 in FIG. 5 to be used as the projection objective 16 in FIG. 2 and 1 in the projection exposure machine 18 in FIG. 1.

The optical system 12 illustrated in FIG. 5 is a dioptric projection objective that is described in the document WO 2003/075096 A2. Reference is made to this document for a detailed description. The optical data of the optical system 12 in FIG. 5 are listed in table 1, the optical surfaces being numbered in the sequence from left (objective side) to right (image side) in FIG. 5.

The projection objective 16 in FIG. 5 has a pupil plane P in whose region the replacing apparatus 50 in FIG. 2 is optionally coupled to the projection objective 16, reference being made to the above description relating to FIG. 2. Optical elements in the form of plane plates are optionally exchanged in the projection objective 16 in or in the vicinity of a pupil plane P.

FIG. 6 illustrates a further exemplary embodiment of an optical system 12 in the form of a projection objective 16, the projection objective 16 in FIG. 6 being a catadioptric projection objective for microlithography. The optical data of the projection objective 16 are listed in table 2, the numbering of the optical surfaces relating to the sequence in the direction of light propagation from left to right.

The projection objective 16 is described in the document WO 2004/019128 A2, reference being made to the description there for further details.

This projection objective 16 has three pupil planes P₁, P₂ and P₃.

One replacing apparatus 50 in accordance with FIG. 2 can respectively be arranged in the region of the pupil plane P₁, P₂ and P₃, the replacing apparatuses 50 in the region of the pupil plane P₁ and P₃ optionally containing plane plates as optical compensation elements, while the replacing apparatus 50 in the region of the pupil plane P₂ contains mirrors in order to replace the mirror S.

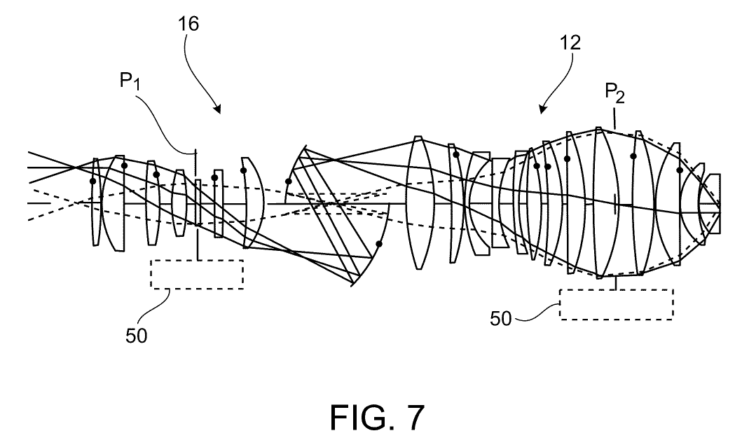

Yet a further exemplary embodiment of the optical system 12 in the form of the projection objective 16 in FIG. 2 is illustrated in FIG. 7. The projection objective 16 is described in the document WO 2005/069055 A2, and the optical data of the projection objective 16 are set forth in table 3, where the numbering of the optical surfaces relates to the sequence in the direction of light propagation from left to right.

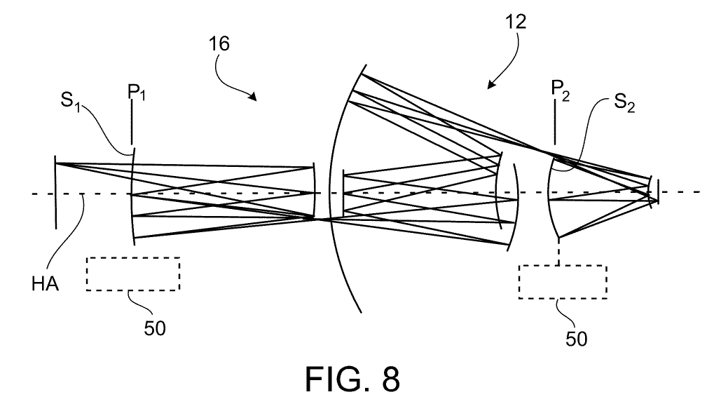

In the case of this projection objective 16, replacing apparatuses 50 at a pupil plane P₁ and a pupil plane P₂ are optionally coupled to the projection objective 16 as described in FIG. 2, the replacing apparatuses 50 optionally containing plane parallel plates as optical compensation elements.

Whereas the projection objectives 16 in FIGS. 5 to 7 operate with light whose operating wavelength is 248 nm or 193 nm, a further exemplary embodiment of an optical system 12 is illustrated in FIG. 8 in the form of the projection objective 16 that operates at a wavelength of 13 nm such that the projection objective 16 in FIG. 8 exclusively has reflective optical elements, that is to say mirrors. The projection objective 16 in FIG. 8 is described in the document U.S. Pat. No. 7,177,076 B2, to which reference is made for further details. The optical data of the projection objective 16 are set forth in table 4, the numbering of the optical surface referring to the sequence in the direction of light propagation from left to right.

The projection objective 16 in FIG. 8 has a pupil plane P₁ and a pupil plane P₂ in the region of two mirrors S₁ and S₂.

These positions are suitable for coupling the replacing apparatus 50 in FIG. 2 to the projection objective 16, although in this case the replacing apparatus 50 has no transmissive plane plates as optical compensation elements, but mirrors that are replaced in the projection objective 16 by the mirrors S₁ and S₂, respectively. Otherwise, the description relating to FIG. 2, in particular the fact that the same atmospheric conditions prevail in the replacing apparatus 50 or its magazine as in the projection objective 16 are also valid here in the region of the mirrors S₁ and S₂.

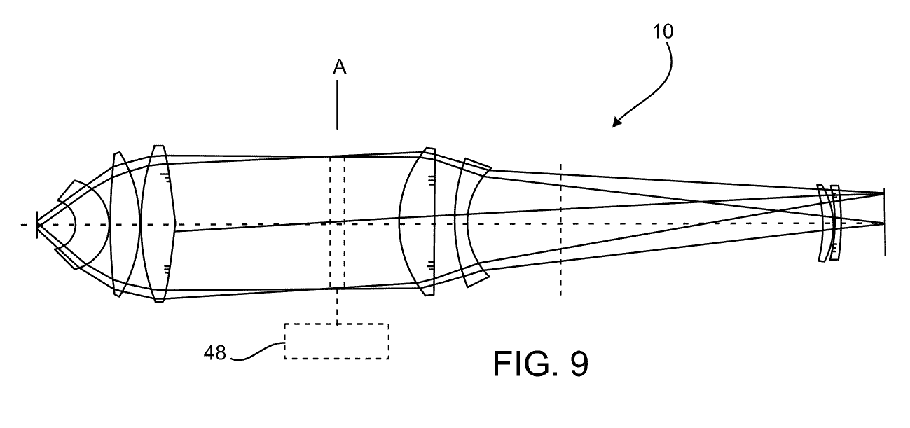

Finally, there is illustrated in FIG. 9 an exemplary embodiment of the optical system 10 in FIG. 1 that illustrates an optically imaging system in the illumination system 14 of the projection exposure machine 18. The optical system 10 serves to image a stop on the object plane 30 in FIG. 1. The optically imaging system is described in the document U.S. Pat. No. 6,366,410 B1, to which reference is made for further details. The optical data of the optical system 10 are listed in table 5, the numbering of the optical surfaces relating to the sequence in the direction of light propagation from left to right.

The replacing apparatus 48 in FIG. 1, to which the description in FIG. 2 with reference to the replacing apparatus 50 likewise applies, is coupled to the optical system 10 in FIG. 9. Here, the site A is suitable as coupling site for the replacing apparatus 48. In the case of the replacing apparatus 48 and the optical system 10, the replacing apparatus 48 is optionally equipped with plane parallel plates that can be introduced into the optical system 10 at the site A and be quickly replaced.

TABLE 1
hna_28_NA09

| | | | | REFRACTIVE | |
|---|---|---|---|---|---|
| | | | | INDEX | ½ FREE |
| SURFACE | RADII | THICKNESSES | GLASSES | 193.304 nm | DIAMETER |
| 0 | 0.000000000 | 34.598670703 | LUPTV193 | 1.00030168 | 66.080 |
| 1 | 0.000000000 | 5.480144837 | LUPTV193 | 1.00030168 | 64.122 |
| 2 | 6478.659586000AS | 10.843585909 | SIO2V | 1.56078570 | 65.807 |
| 3 | −1354.203087330 | 2.423172128 | N2VP950 | 1.00029966 | 66.705 |
| 4 | −1087.803716660 | 9.621961389 | SIO2V | 1.56078570 | 67.029 |
| 5 | 183.366808766 | 2.746190505 | N2VP950 | 1.00029966 | 70.249 |
| 6 | 206.367008633AS | 8.085673658 | SIO2V | 1.56078570 | 71.462 |
| 7 | 197.387116101 | 36.794320510 | N2VP950 | 1.00029966 | 72.483 |
| 8 | −140.799169619 | 50.098071588 | SIO2V | 1.55078570 | 73.484 |
| 9 | −373.463518266 | 1.000056376 | N2VP950 | 1.00029966 | 103.736 |
| 10 | −561.452806488 | 22.561578822 | SIO2V | 1.66078570 | 107.508 |
| 11 | −263.612680429 | 1.000766794 | N2VP950 | 1.00029966 | 111.862 |
| 12 | −49192.554837400AS | 53.841314203 | SIO2V | 1.36078570 | 124.515 |
| 13 | −266.359005048 | 15.247580669 | N2VP950 | 1.00029966 | 130.728 |
| 14 | 840.618794866 | 29.011390428 | SIO2V | 1.56078570 | 141.816 |
| 15 | −926.722502535 | 1.005611320 | N2VP950 | 1.00029966 | 142.120 |
| 16 | 2732.904696180 | 38.725041629 | SIO2V | 1.56078570 | 141.999 |
| 17 | −356.203262496AS | 2.005496104 | N2VP950 | 1.00029966 | 141.858 |
| 18 | 318.151930355 | 16.617316424 | SIO2V | 1.56078570 | 124.740 |
| 19 | 513.819497301 | 1.562497532 | N2VP950 | 1.00029966 | 122.663 |
| 20 | 171.455700974 | 30.277693674 | SIO2V | 1.56078570 | 111.385 |
| 21 | 154.841382726 | 1.064445848 | N2VP950 | 1.00029966 | 98.077 |
| 22 | 127.756841801 | 43.191494812 | SIO2V | 1.56078570 | 94.695 |
| 23 | 104.271940246 | 52.476004091 | N2VP950 | 1.00029966 | 74.378 |
| 24 | −283.692700248 | 8.000000007 | SIO2V | 1.56078570 | 68.565 |
| 25 | 242.925344027 | 39.949818972 | N2VP950 | 1.00029966 | 64.404 |
| 26 | −117.414778719 | 8.181191942 | SIO2V | 1.56078570 | 63.037 |
| 27 | 197.144513187 | 26.431580314 | N2VP950 | 1.00029966 | 69.190 |
| 28 | −244.477949870 | 44.225451360 | SIO2V | 1.56078570 | 71.085 |
| 29 | −230.856430065 | 1.405104251 | N2VP950 | 1.00029966 | 88.427 |
| 30 | 1472.096760620AS | 21.137736519 | SIO2V | 1.56078570 | 99.340 |
| 31 | −450.715283484 | 1.25933876 | N2VP950 | 1.00029966 | 101.126 |
| 32 | 3573.378947270 | 8.391191259 | SIO2V | 1.56078570 | 105.206 |
| 33 | 7695.066698120 | 1.258010005 | N2VP950 | 1.00029966 | 106.474 |
| 34 | 1029.326174920 | 8.390466230 | SIO2V | 1.56078570 | 108.186 |
| 35 | 243.058844043 | 29.823514356 | N2VP950 | 1.00029966 | 112.152 |
| 36 | 29057.985214100 | 38.911793339 | SIO2V | 1.56078570 | 114.058 |
| 37 | −232.205630921 | 1.000000003 | N2VP950 | 1.00029966 | 116.928 |
| 38 | 270.144711058 | 55.850950401 | SIO2V | 1.56078570 | 119.162 |
| 39 | 1183.955771760AS | 20.935175304 | N2VP950 | 1.00029966 | 138.048 |
| 40 | 0.000000000 | −2.958030543 | N2VP950 | 1.00029966 | 138.244 |
| 41 | 368.838236812 | 22.472409726 | SIO2V | 1.56078570 | 141.049 |
| 42 | 220.058626892 | 26.974361640 | N2VP950 | 1.00029966 | 137.707 |
| 43 | 355.728536436 | 58.022036072 | SIO2V | 1.56078570 | 140.923 |
| 44 | −861.478061183AS | 4.104303800 | N2VP950 | 1.00029966 | 142.103 |
| 45 | 420.713002153 | 55.049896341 | SIO2V | 1.56078570 | 142.502 |
| 46 | −478.998238339 | 1.000000000 | N2VP950 | 1.00029966 | 141.431 |
| 47 | 122.579574949 | 48.569396230 | SIO2V | 1.56078570 | 106.623 |
| 48 | 323.612364366AS | 1.000000000 | N2VP950 | 1.00029966 | 99.428 |
| 49 | 132.028746911 | 49.487311459 | SIO2V | 1.56078570 | 88.176 |
| 50 | 247.223694320 | 10.595001724 | N2VP950 | 1.00029966 | 65.249 |
| 51 | 712.954951376AS | 8.355490390 | SIO2V | 1.56078570 | 57.430 |
| 52 | 163.735058824 | 3.094306970 | N2VP950 | 1.00029966 | 47.446 |
| 53 | 154.368612651 | 19.294967287 | SIO2V | 1.56078570 | 44.361 |
| 54 | 677.158668491 | 2.851896407 | N2VP950 | 1.00029966 | 33.956 |
| 55 | 0.000000000 | 10.000000000 | SIO2V | 1.56078570 | 29.686 |
| 56 | 0.000000000 | 4.000000000 | LUPTV193 | 1.00030168 | 22.559 |
| 57 | 0.000000000 | 0.000000000 | | 1.00000000 | 14.020 |

ASPHERIC CONSTANTS
SURFACE NO. 2

| | |
|---|---|
| K | 0.0000 |
| C1 | 1.38277367e−007 |
| C2 | −1.88982133e−011 |
| C3 | 1.94699866e−015 |
| C4 | −3.04512613e−019 |
| C5 | 3.31424645e−023 |
| C6 | −2.70316185e−027 |
| C7 | 1.30470314e−031 |
| C8 | 0.00000000e+000 |
| C9 | 0.00000000e+000 |

SURFACE NO. 6

| | |
|---|---|
| K | 0.0000 |
| C1 | −1.02654080e−008 |
| C2 | 1.22477004e−011 |
| C3 | −1.70636250e−015 |
| C4 | 2.48526394e−019 |
| C5 | −2.38582445e−023 |
| C6 | 1.51451580e−027 |
| C7 | −6.30610228e−032 |
| C8 | 0.00000000e+000 |
| C9 | 0.00000000e+000 |

SURFACE NO. 12

| | |
|---|---|
| K | 0.0000 |
| C1 | −3.36870323e−009 |
| C2 | 1.77350477e−013 |
| C3 | 1.19052376e−019 |
| C4 | −1.17127296e−022 |
| C5 | −9.25382522e−027 |
| C6 | 4.88058037e−031 |
| C7 | −1.32782815e−035 |
| C8 | 0.00000000e+000 |
| C9 | 0.00000000e+000 |

SURFACE NO. 17

| | |
|---|---|
| K | 0.0000 |
| C1 | 2.29017476e−010 |
| C2 | 4.92394931e−014 |
| C3 | 2.34180010e−019 |
| C4 | −2.74433865e−023 |
| C5 | 8.02938234e−029 |
| C6 | −1.05282366e−032 |
| C7 | −1.44319713e−038 |
| C8 | 0.00000000e+000 |
| C9 | 0.00000000e+000 |

SURFACE NO. 30

| | |
|---|---|
| K | 0.0000 |
| C1 | −1.51349530e−008 |
| C2 | 9.73999326e−013 |
| C3 | 8.62745113e−018 |
| C4 | 5.94720340e−022 |
| C5 | −4.71903409e−026 |
| C6 | 2.87654316e−031 |
| C7 | 4.40822786e−035 |
| C8 | 0.00000000e+000 |
| C9 | 0.00000000e+000 |

SURFACE NO. 39

| | |
|---|---|
| K | 0.0000 |
| C1 | 5.16807805e−009 |
| C2 | −6.62986543e−014 |
| C3 | −6.91577796e−019 |
| C4 | −3.62532300e−024 |
| C5 | −1.38222518e−027 |
| C6 | 1.06689880e−031 |
| C7 | −1.65303231e−036 |
| C8 | 0.00000000e+000 |
| C9 | 0.00000000e+000 |

SURFACE NO. 44

| | |
|---|---|
| K | 0.0000 |
| C1 | −3.74086200e−009 |
| C2 | 9.09495287e−014 |
| C3 | −9.58269360e−019 |
| C4 | 2.46215375e−023 |
| C5 | −8.23397865e−028 |
| C6 | 1.33400957e−032 |
| C7 | −5.95002910e−037 |
| C8 | 0.00000000e+000 |
| C9 | 0.00000000e+000 |

SURFACE NO. 48

| | |
|---|---|
| K | 0.0000 |
| C1 | −2.07951112e−009 |
| C2 | −3.24793684e−014 |
| C3 | −4.06763808e−018 |
| C4 | −4.85274422e−022 |
| C5 | 2.39376432e−027 |
| C6 | 2.44680800e−030 |
| C7 | −5.62502628e−035 |
| C8 | 0.00000000e+000 |
| C9 | 0.00000000e+000 |

SURFACE NO. 51

| | |
|---|---|
| K | 0.0000 |
| C1 | −6.57068732e−009 |
| C2 | 2.35659016e−012 |
| C3 | −1.23585829e−016 |
| C4 | 5.34284269e−020 |
| C5 | −1.12897797e−023 |
| C6 | 1.37710849e−027 |
| C7 | −1.15065048e−031 |
| C8 | 0.00000000e+000 |
| C9 | 0.00000000e+000 |

TABLE 2

| Surface no. | r (mm) | d (mm) | Material |
|---|---|---|---|
| Object plane | ∞ | 81.9091 | |
| 601: | 2634.49417 | 21.2504 | Quartz |
| 602: | −395.77168 | 1.0000 | |
| 603: | 150.00000 | 50.0000 | Quartz |
| 604: | 369.68733 | 54.9152 | |
| 605: | 179.71446 | 34.0668 | Quartz |
| 606: | ASP-1 | 6.6932 | |
| 607: | 68.93816 | 50.0000 | Quartz |
| 608: | 91.86919 | 23.6059 | |
| 609: | −98.63242 | 50.0000 | Quartz |
| 610: | −88.50693 | 12.0495 | |
| 611: | −76.47008 | 38.6573 | Quartz |
| 612: | −344.46033 | 15.7028 | |
| 613: | −334.92667 | 50.0661 | Quartz |
| 614: | −117.23873 | 1.0000 | |
| 615: | ASP-2 | 43.8116 | Quartz |
| 616: | −181.49712 | 1.0000 | |
| 617: | 289.19628 | 27.8483 | Quartz |
| 618: | 5892.12201 | 12.1517 | |
| 619: | 227.01362 | 27.1570 | Quartz |
| 620: | ASP-3 | 69.0000 | |
| 621: | ∞ | −236.5118 | (M1) |
| 622: | ASP-4 | −12.5000 | Quartz |
| 623: | 1144.45984 | −50.1326 | |
| 624: | 110.85976 | −12.5000 | Quartz |
| 625: | 213.24820 | −26.1588 | |
| 626: | 155.15866 | 26.1588 | (CM) |
| 627: | 213.24820 | 12.5000 | Quartz |
| 628: | 110.85976 | 50.1326 | |
| 629: | 1144.45984 | 12.5000 | Quartz |
| 630: | ASP-4 | 236.5115 | |
| 631: | ∞ | −64.0489 | (M2) |
| 632: | 3037.95158 | −22.3312 | Quartz |
| 633: | 259.31045 | −1.0000 | |
| 634: | −470.92329 | −24.5450 | Quartz |
| 635: | 700.75092 | −1.0000 | |
| 636: | −228.28898 | −45.9798 | Quartz |
| 637: | −4362.48907 | −1.0000 | |
| 638: | −147.00156 | −50.0000 | Quartz |
| 639: | ASP-5 | −13.1758 | |
| 640: | 810.59426 | −12.5000 | Quartz |
| 641: | ASP-6 | −40.9252 | |
| 642: | −2113.41076 | −12.5000 | Quartz |
| 643: | ASP-7 | −16.1803 | |
| 644: | −562.31334 | −30.6677 | Quartz |
| 645: | 1126.84825 | −80.2339 | |
| 646: | ASP-8 | −22.6585 | Quartz |
| 647: | 586.42927 | −1.0000 | |
| 648: | −361.03935 | −33.1534 | Quartz |
| 649: | −3170.02757 | −1.0000 | |
| 650: | −310.02927 | −49.2493 | Quartz |
| 651: | ASP-9 | −9.8662 | |
| 652: | ∞ | −5.3722 | Aperture |
| 653: | −777.31707 | −35.8824 | Quartz |
| 654: | 1312.61222 | −1.0007 | |
| 655: | −319.73575 | −35.9439 | Quartz |
| 656: | 3225.49072 | −1.0000 | |
| 657: | −130.49530 | −28.4950 | Quartz |
| 658: | ASP-10 | −1.0000 | |
| 659: | −95.22134 | −34.3036 | Quartz |
| 660: | ASP-11 | −1.0000 | |
| 661: | −61.85167 | −50.0000 | Quartz |
| 662: | ∞ | −1.0000 | Deionized |
| | | | water |
| Image plane | ∞ | | |

| Asphere | Curvature | K | A | B | C | D |
|---|---|---|---|---|---|---|
| no. | (Curve) | E | F | G | H | J |
| ASP-1 | −0.00209291 | 0 | 7.81812 × 10⁻² | 6.03387 × 10⁻¹⁸ | 3.16794 × 10⁻¹ [symbol] | −3.45599 × 10⁻²⁰ |
| | | 1.67628 × 10⁻²⁴ | 0 | 0 | 0 | 0 |
| ASP-2 | −0.00252931 | 0 | −1.14807 × 10⁻ [symbol] | 4.60861 × 10⁻ [symbol] | −1.61766 × 10⁻¹⁷ | −5.41414 × 10⁻²⁴ |
| | | 5.36076 × 10⁻²⁷ | −1.16131 × 10⁻ [symbol] | 0 | 0 | 0 |
| ASP-3 | 0.00029038 | 0 | 1.29830 × 10⁻ [symbol] | 2.79320 × 10⁻¹⁸ | −1.95862 × 10⁻¹⁷ | 6.49039 × 10⁻²² |
| | | −1.02409 × 10⁻²⁶ | −4.06450 × 10⁻¹² | 0 | 0 | 0 |
| ASP-4 | 0.00934352 | 0 | − [symbol] .88014 × 10⁻ [symbol] | −3.40911 × 10⁻¹² | −1.98985 × 10⁻¹² | −1.45801 × 10⁻²⁰ |
| | | −9.23086 × 10⁻²⁶ | −1.30730 × 10⁻²⁹ | 0 | 0 | 0 |
| ASP-5 | −0.00197848 | 0 | −3.21829 × 10⁻ [symbol] | 4.09976 × 10⁻ [symbol] | 9.46190 × 10⁻¹⁷ | −1.12686 × 10⁻²⁰ |
| | | 1.09349 × 10⁻ [symbol] | −2.30304 × 10⁻ [symbol] | 0 | 0 | 0 |
| ASP-6 | −0.0104007 | 0 | −1.40846 × 10⁻ [symbol] | 3.73235 × 10⁻¹² | 6.78170 × 10⁻¹⁷ | 4.02044 × 10⁻²⁰ |
| | | 1.81116 × 10⁻²⁴ | −3.46502 × 10⁻²³ | | | |
| ASP-7 | −0.00889746 | 0 | 3.76564 × 10⁻ [symbol] | 2.04566 × 10⁻¹² | 8.72661 × 10⁻¹⁷ | 3.35779 × 10⁻ [symbol] |
| | | −5.51578 × 10⁻²⁵ | 2.95829 × 10⁻ [symbol] | 0 | 0 | 0 |
| ASP-8 | −0.00029365 | 0 | 1.54429 × 10⁻ [symbol] | −1.52631 × 10⁻¹⁸ | −1.17235 × 10⁻¹⁷ | −3.02626 × 10⁻²² |
| | | −2.05070 × 10⁻²² | 3.51487 × 10⁻³¹ | 0 | 0 | 0 |
| ASP-9 | 0.00123523 | 0 | −9.78469 × 10⁻ [symbol] | 2.15545 × 10⁻¹⁴ | −2.66488 × 10⁻¹⁷ | 1.19902 × 10⁻²¹ |
| | | −2.60321 × 10⁻²⁶ | 2.10016 × 10⁻²¹ | 0 | 0 | 0 |
| ASP-10 | −0.00508157 | 0 | 2.76215 × 10⁻ [symbol] | −4.06793 × 10⁻¹² | 4.51389 × 10⁻¹² | −5.07074 × 10⁻²⁰ |
| | | 1.83976 × 10⁻²⁵ | −6.22513 × 10⁻ [symbol] | 0 | 0 | 0 |
| ASP-11 | −0.00460959 | 0 | −1.08226 × 10⁻²⁷ | −9.51194 × 10⁻¹² | 1.14805 × 10⁻¹⁸ | −1.27400 × 10⁻ [symbol] |
| | | 1.59436 × 10⁻ [symbol] | −5.73173 × 10⁻²⁸ | 0 | 0 | 0 |

[symbol]

indicates data missing or illegible when filed

TABLE 3

| Surface | Radius | Asphere | Thickness | Material | ½ diameter |
|---|---|---|---|---|---|
| 1 | 0.000000 | | −0.011620 | LV193975 | 75.462 |
| 2 | 585.070331 | AS | 17.118596 | SIO2V | 76.447 |
| 3 | −766.901651 | | 0.890181 | HEV19397 | 78.252 |
| 4 | 145.560665 | | 45.675278 | SIO2V | 85.645 |
| 5 | 2818.543789 | AS | 40.269525 | HEV19397 | 83.237 |
| 6 | 469.396236 | | 29.972759 | SIO2V | 75.894 |
| 7 | −193.297708 | AS | 21.997025 | HEV19397 | 73.717 |
| 8 | 222.509238 | | 27.666963 | SIO2V | 57.818 |
| 9 | −274.231957 | | 31.483375 | HEV19397 | 52.595 |
| 10 | 0.000000 | | 10.117766 | SIO2V | 44.115 |
| 11 | 0.000000 | | 15.381487 | HEV19397 | 47.050 |
| 12 | 26971.109897 | AS | 14.803554 | SIO2V | 54.127 |
| 13 | −562.070426 | | 45.416373 | HEV19397 | 58.058 |
| 14 | −510.104298 | AS | 35.926312 | SIO2V | 76.585 |
| 15 | −118.683707 | | 36.432152 | HEV19397 | 80.636 |
| 16 | 0.000000 | | 199.241665 | HEV19397 | 86.561 |
| 17 | −181.080772 | AS | −199.241665 | REFL | 147.684 |
| 18 | 153.434246 | AS | 199.241665 | REFL | 102.596 |
| 19 | 0.000000 | | 36.432584 | HEV19397 | 105.850 |
| 20 | 408.244008 | | 54.279598 | SIO2V | 118.053 |
| 21 | −296.362521 | | 34.669451 | HEV19397 | 118.398 |
| 22 | −1378.452784 | | 22.782283 | SIO2V | 106.566 |
| 23 | −533.252331 | AS | 0.892985 | HEV19397 | 105.292 |
| 24 | 247.380841 | | 9.992727 | SIO2V | 92.481 |
| 25 | 103.088603 | | 45.957039 | HEV19397 | 80.536 |
| 26 | −1832.351074 | | 9.992069 | SIO2V | 80.563 |
| 27 | 151.452362 | | 28.883857 | HEV19397 | 81.238 |
| 28 | 693.739003 | | 11.559320 | SIO2V | 66.714 |
| 29 | 303.301679 | | 15.104783 | HEV19397 | 91.779 |
| 30 | 1016.426625 | | 30.905849 | SIO2V | 95.900 |
| 31 | −258.080954 | AS | 10.647394 | HEV19397 | 99.790 |
| 32 | −1386.614747 | AS | 24.903261 | SIO2V | 108.140 |
| 33 | −305.810572 | | 14.249112 | HEV19397 | 112.465 |
| 34 | −11755.658826 | AS | 32.472684 | SIO2V | 124.075 |
| 35 | −359.229865 | | 16.650084 | HEV19397 | 126.831 |
| 36 | 1581.896158 | | 51.095339 | SIO2V | 135.151 |
| 37 | −290.829022 | | −5.686977 | HEV19397 | 136.116 |
| 38 | 0.000000 | | 0.000000 | HEV19397 | 131.224 |
| 39 | 0.000000 | | 28.354383 | HEV19397 | 131.224 |
| 40 | 524.037274 | AS | 45.635992 | SIO2V | 130.144 |
| 41 | −348.286331 | | 0.878010 | HEV19397 | 129.553 |
| 42 | 184.730622 | | 45.614622 | SIO2V | 108.838 |
| 43 | 2501.302312 | AS | 0.854125 | HEV19397 | 103.388 |
| 44 | 69.832394 | | 38.416586 | SIO2V | 73.676 |
| 45 | 209.429378 | | 0.697559 | HEV19397 | 63.921 |
| 46 | 83.525032 | | 37.916651 | CAF2V193 | 50.040 |
| 47 | 0.000000 | | 0.300000 | SIO2V | 21.480 |
| 48 | 0.000000 | | 0.000000 | SIO2V | 21.116 |
| 49 | 0.000000 | | 3.000000 | H2OV193B | 21.116 |
| 50 | 0.000000 | | 0.000000 | AIR | 16.500 |

Aspheric constants

| | Surface | | | | |
|---|---|---|---|---|---|
| | 2 | 5 | 7 | 12 | 14 |
| K | 0 | 0 | 0 | 0 | 0 |
| C1 | −5.72E−02 | −4.71E−02 | 1.75E−01 | −8.29E−02 | −4.35E−02 |
| C2 | −2.97E−07 | 7.04E−06 | −1.17E−08 | −1.67E−07 | 1.59E−06 |
| C3 | 1.03E−12 | 1.09E−10 | 1.34E−09 | −7.04E−10 | −6.81E−11 |
| C4 | 2.76E−14 | −2.90E−14 | −5.44E−14 | 6.65E−14 | 5.03E−15 |
| C5 | −1.51E−16 | −1.55E−21 | −1.82E−16 | −1.33E−17 | −1.66E−23 |
| C6 | −1.04E−24 | 5.61E−23 | 2.56E−22 | 2.46E−21 | −2.36E−23 |
| C7 | 0.000000e+00 | 0.000000e+00 | 0.000000e+00 | 0.000000e+00 | 0.000000e+00 |
| C8 | 0.000000e+00 | 0.000000e+00 | 0.000000e+00 | 0.000000e+00 | 0.000000e+00 |
| C9 | 0.000000e+00 | 0.000000e+00 | 0.000000e+00 | 0.000000e+00 | 0.000000e+00 |
| | Surface | | | | |
| | 17 | 18 | 23 | 31 | 32 |
| K | −197.849 | −204.054 | 0 | 0 | 0 |
| C1 | −2.94E−02 | 5.77E−02 | −7.06E−02 | 3.41E−02 | −4.85E−02 |
| C2 | 2.63E−07 | −5.00E−07 | 4.11E−06 | 4.07E−08 | 9.88E−07 |
| C3 | −6.11E−12 | 2.67E−11 | −1.18E−10 | 8.10E−11 | 7.37E−11 |
| C4 | 1.11E−16 | −5.69E−16 | 2.92E−15 | −4.34E−15 | −6.56E−15 |
| C5 | −2.01E−21 | 1.89E−20 | −3.23E−20 | 7.59E−19 | 6.53E−19 |
| C6 | 2.08E−26 | −1.49E−25 | 2.18E−25 | −3.41E−23 | −2.88E−23 |
| C7 | 0.000000e+00 | 0.000000e+00 | 0.000000e+00 | 0.000000e+00 | 0.000000e+00 |
| C8 | 0.000000e+00 | 0.000000e+00 | 0.000000e+00 | 0.000000e+00 | 0.000000e+00 |
| C9 | 0.000000e+00 | 0.000000e+00 | 0.000000e+00 | 0.000000e+00 | 0.000000e+00 |

| | Surface | | |
|---|---|---|---|
| | 34 | 40 | 4 |
| K | 0 | 0 | 0 |
| C1 | 1.59E−02 | −4.10E−02 | −3.89E−02 |
| C2 | −1.51E−06 | 3.04E−07 | 4.76E−06 |
| C3 | 6.62E−13 | 5.71E−11 | −2.23E−10 |
| C4 | 1.72E−15 | −1.72E−15 | 6.89E−15 |
| C5 | −9.36E−20 | −9.60E−22 | −2.41E−19 |
| C6 | 2.36E−24 | 3.81E−25 | 3.43E−24 |
| C7 | 0.000000e+00 | 0.000000e+00 | 0.000000e+00 |
| C8 | 0.000000e+00 | 0.000000e+00 | 0.000000e+00 |
| C9 | 0.000000e+00 | 0.000000e+00 | 0.000000e+00 |

TABLE 4

| ELEMENT | | | | |
|---|---|---|---|---|
| NUMBER | RADIUS | THICKNESS | DIAMETER | TYPE |
| OBJECT | [symbol] | 437.8550 | | |
| 1 | A(2) | −248. [symbol] | 218.4102 | REFL |
| | | APERTURE | | |
| | | DIAP [symbol] | [symbol] | |
| | | 0. [symbol] 000 | | |
| 2 | A(2) | 293. [symbol] | 82.5770 | REFL |
| 3 | A(3) | −230. [symbol] 03 | [symbol] | REFL |
| 4 | [symbol] (4) | 618.7 [symbol] | −320.2546 | REFL |
| 5 | A(5) | −269. [symbol] 752 | 398.39 [symbol] | REFL |
| 6 | A(6) | 202.7 [symbol] 00 | [symbol] | REFL |
| 7 | A(7) | −283.6734 | 85. [symbol] | REFL |
| 8 | A(8) | 326. [symbol] | 30 [symbol] | R [symbol] |
| [symbol] | IHF | | 55.0227 | |

ASPHERIC CONSTANT
$Z = \frac{( CURVE ) {Y}^{2}}{1 + {( 1 - ( 2 \text{?} ) {( CURVE )}^{2} {Y}^{2} )}^{1 / 2}} + ( A ) {Y}^{4} + {( B )}^{6} + ( C ) {Y}^{8} + ( D ) {Y}^{10} + ( E ) {Y}^{12} + ( F ) {Y}^{14} + ( G ) {Y}^{16} + ( H ) {Y}^{18} + ( J ) {Y}^{20}$ $\text{?} \text{indicates text missing or illegible when filed}$

| | | K | A | [symbol] | C | [symbol] |
|---|---|---|---|---|---|---|
| CURVATURE | CURVE | E | F | G | H | J |
| A(1) | −0.00123747 | 0.000000 | −2.32222E−09 | −1.20 [symbol] E−14 | 5.14512E−15 | −3. [symbol] E−23 |
| | | 2.27258E−27 | −4.4 [symbol] E−32 | 0.00000E+00 | 0.00000E+00 | 0.00000E+00 |
| A(2) | 0.000 [symbol] | 0.000000 | [symbol] | −2.2 [symbol] | − [symbol] | [symbol] |
| | | −4.21257E−24 | [symbol] | 0.00000E+00 | 0.00000E+00 | 0.00000E+00 |
| A(3) | −0.000 [symbol] | 0.000000 | [symbol] | −7. [symbol] | [symbol] | 5.15 [symbol] |
| | | [symbol] | [symbol] | 0.0000 [symbol] | 0.00000E+00 | 0.00000E+00 |
| A(4) | 0.000 [symbol] | 0.000000 | [symbol] | 2.5 [symbol] | [symbol] | [symbol] |
| | | −3.34527E−29 | [symbol] | 0.00000E+00 | 0.00000E+00 | 0.00000E+00 |
| A(5) | −0.00 [symbol] | 0.000000 | [symbol] | [symbol] | [symbol] | −1.6 [symbol] |
| | | 6.43317E−30 | [symbol] | 0.00000E+00 | 0.00000E+00 | 0.00000E+00 |
| A(6) | −0.00 [symbol] | 0.000000 | 2.5 [symbol] | −2.4 [symbol] | 7.4 [symbol] | −1. [symbol] |
| | | 2.34840E−28 | [symbol] | 0.00000E+00 | 0.00000E+00 | 0.00000E+00 |
| A(7) | 0.005 [symbol] | 0.000000 | [symbol] | [symbol] | [symbol] | −6.3565E−20 |
| | | [symbol] | [symbol] | 0.00000E+00 | 0.00000E+00 | 0.00000E+00 |
| A(8) | 0.00 [symbol] | 0.000000 | [symbol] | 3.13817E−25 | 2.23903E−20 | 1.62 [symbol] |
| | | [symbol] | [symbol] | 0.00000E+00 | 0.00000E+00 | 0.00000E+00 |

Wavelength = 13.0 nm
Magnification ratio = 0.25
Image-side aperture = 0.40 [symbol]
indicates data missing or illegible when filed

TABLE 5

| | |
|---|---|
| Scale: 4.444:1 | Wavelength: 248.33 nm |

| | Radius | Thickness | Material |
|---|---|---|---|
| 1 | | 55.240 | |
| 2 | −38.258 | 46.424 | Quartz |
| 3 | −66.551 | .633 | |
| 4 | 881.696 | 45.341 | Quartz |
| 5 | −190.791 | .924 | |
| 6 | 374.111 | 47.958 | Quartz |
| 7 | −287.518 | 222.221 | |
| 8 | Diaphragm | 17.900 | |
| 9 | ∞ | 79.903 | |
| 10 | 164.908 | 52.350 | Quartz |
| 11 | −1246.141 | 27.586 | |
| 12 | 280.226 | 19.580 | Quartz |
| 13 | 114.495 | 133.941 | |
| 14 | ∞ | 365.253 | |
| 15 | −216.480 | 12.551 | Quartz |
| 16 | −113.446 | 1.399 | |
| 17 | −329.056 | 10.797 | Quartz |
| 18 | −552.687 | 60.000 | |
| 19 | ∞ | .000 | |

| Surface | Aspheric constants |
|---|---|
| 7 | K = −.00640071 C1 = .347156E−07 C2 = .802432E−13 |
| | C3 = −.769512E−17 C4 = .157667E−21 |
| 11 | K = +.00104108 C1 = .431697E−07 C2 = −.564977E−13 |
| | C3 = −.125201E−16 C4 = .486357E−21 |
| 17 | K = +.00121471 C1 = −.991033E−07 C2 = −.130790E−11 |
| | C3 = −.414621E−14 C4 = .200482E−17 C5 = −.392671E−21 |

1.-26. (canceled)

27. A system, comprising:
an optical system comprising a plurality of optical elements;
a replacing apparatus coupled to the optical system; and
a plurality of optical compensation elements in the replacing apparatus, wherein the replacing apparatus can be used to replace at least one of the plurality of the optical elements with at least one of the plurality of optical compensation elements.

28. The system as claimed in claim 27, further comprising a detection device configured to detect a time-dependent, at least partially reversible aberration of the optical system that is caused by heating of at least one of the plurality of optical elements.

29. The optical system as claimed in claim 28, wherein the detection device comprises a device configured to measure a wavefront of the optical system and/or a light distribution of the optical system, and the detection device comprises an arithmetic logic unit configured to process signals which the device can provide to the arithmetic logic unit, and to drive the replacing apparatus.

30. The optical system as claimed in claim 27, wherein the replacing apparatus has a magazine in which the plurality of optical compensation elements are accommodated, the magazine is coupled to the optical system, and same atmospheric conditions prevail in the magazine as in a region where the optical system is coupled to the magazine.

31. The optical system as claimed in claim 30, wherein the atmospheric conditions include the gas composition in the region.

32. The optical system as claimed in claim 30, wherein the atmospheric conditions include the pressure and/or the temperature in the region.

33. The optical system as claimed in claim 27, wherein the replacing apparatus is arranged outside a beam path of the optical system.

34. The optical system as claimed in claim 27, wherein the replacing apparatus on its own can be used to introduce the compensation element into a beam path of the optical system.

35. The optical system as claimed in claim 27, wherein the plurality of optical compensation elements include the optical compensation element and an additional optical compensation element, and the optical compensation component and the additional optical compensation component can be introduced simultaneously into a beam path of the optical system by the replacing apparatus.

36. The optical system as claimed in claim 27, wherein the plurality of optical compensation elements include the optical compensation element and an additional optical compensation element, and the optical compensation component and the additional optical compensation component can be introduced into the optical system in a pupil plane or near a pupil, in a field plane or near the field, and/or at intermediate positions.

37. The optical system as claimed in claim 27, wherein the optical elements and the compensation elements are plane parallel plates, lenses and/or as mirrors.

38. The optical system as claimed in claim 27, wherein the optical compensation elements are plane parallel plates and have second-, third-, fourth- and/or nth-order fit errors with various amplitudes.

39. The optical system as claimed in claim 27, wherein the optical compensation elements are plane parallel plates having rotationally or non-rotationally symmetrical fit errors.

40. The optical system as claimed in claim 27, wherein the optical compensation elements are plane parallel plates having non-rotationally symmetrical fit errors and a substantially cylindrical or conical periphery.

41. The optical system as claimed in claim 38, wherein the fit errors are determined by Zernike functions and/or splines.

42. The optical system as claimed in claim 27, wherein the optical compensation element and/or the optical elements can be introduced into the optical system and can be rotated, tilted with reference to an optical axis of the optical system, and/or displaced in the optical system.

43. The optical system as claimed in claim 27, wherein the optical system comprises mechanical manipulators and/or thermal manipulators that can aid in deforming the optical compensation element and/or the optical elements by mechanical force action and/or thermal force action.

44. The optical system as claimed in claim 27, wherein a wavelength and/or an irradiation dose can be varied by light beams incident on the optical system.

45. The optical system as claimed in claim 27, wherein the optical system is a projection objective of a projection exposure machine for microlithography.

46. The optical system as claimed in claim 45, wherein the projection objective is a dioptric, catadioptric or catoptric imaging system.

47. The optical system as claimed in claim 27, wherein the optical system is arranged in an illumination system of a projection exposure machine for microlithography.

48. The optical system as claimed in claim 45, wherein the optical system is a dioptric, catadioptric or catoptric imaging system.

49. A system as claimed in one of claim 27, wherein the operating wavelength of the optical system is 248, 193 or 13 nm.
